(19) United States
(12) Patent Application Publication
(10) Pub. No.: US 2014/0174137 A1
(43) Pub. Date: Jun. 26, 2014

(54) Lock in Cooperation with Mating Pieces

(71) Applicant: SINOXLOCK (KUNSHAN) CO., LTD., Jiangsu (CN)

(72) Inventor: HeFei Xue, Jiangsu (CN)

(73) Assignee: SINOXLOCK (KUNSHAN) CO., LTD., Jiangsu (CN)

(21) Appl. No.: 14/135,596

(22) Filed: Dec. 20, 2013

Related U.S. Application Data
(60) Provisional application No. 61/772,569, filed on Mar. 5, 2013.

(30) Foreign Application Priority Data
Dec. 21, 2012 (CN) 201210560814.1

(51) Int. Cl. E05B 57/00

(52) U.S. Cl. CPC E05B 57/00
USPC 70/15; 70/14

(57) ABSTRACT

A lock structure including a base and a door portion, a lock mechanism and a locking section, and a first mating element is provided. The door portion is pivotally connected to one end of the base portion by a pivot and is switched between an open and a close status. One of the base portion and the door portion comprises a first opening, the other comprises a first securing element close to the first opening. The lock mechanism and the locking section are disposed at the door and the base portion, respectively, and correspond to each other. The first mating element comprises a first engaging portion selectively connected to or detached from the first opening, wherein the first securing element restricts the first engaging portion from being detached from the first opening when the first engaging portion is located at the first opening and the door portion is closed.

### BACKGROUND OF THE INVENTION

1. Field of the Invention

The present invention generally relates to a lock structure. Particularly, the present invention relates to a lock structure, which can be used in cooperation with a variety of mating pieces/elements including steel wire, strap, chain, or tongue portion of an electronic product.

2. Description of the Prior Art

Lock structures having long-shaped object provided at present include, for example, lock with steel wire for computer, lock with strap for tying up luggage. One end of the long-shaped object mentioned above is connected to the lock and is not separable therefrom, wherein the lock is usually manufactured according to a specific purpose, which is usually a sole purpose. For example, the burglarproof lock structure for electronic product has the lock mechanism connected to a steel wire, which has one end formed in a ring structure, and the ring portion is secured to a stationary object, such as furniture. In addition, the burglarproof lock structure for electronic product has its unlocking and locking mechanism manufactured in accordance with a lock hole of the electronic product. Accordingly, the burglarproof lock structure for electronic product cannot be used as a burglarproof lock structure for bicycle or in tying luggage up.

### SUMMARY OF THE INVENTION

In this regard, the present invention provides a lock structure for being used in cooperation with a variety of mating pieces/elements in accordance with burglarproof requirement on computers, bicycles, luggage-packing, or other purposes.

The lock structure of the present invention includes a base portion, a door portion, a lock mechanism, a locking section, and a first mating piece/element. The door portion is pivotally connected to one end of the base portion by a pivot. One of the base portion and the door portion includes a first opening and the other includes a first securing element close to the first opening. The lock mechanism and the locking section are disposed at the door portion and the base portion, respectively, wherein the lock mechanism and the locking section correspond to each other. One end of the first mating element includes a first engaging portion selectively connected to or detached from the first opening, wherein the first securing element restricts the first engaging portion from being detached from the first opening when the first engaging portion is located at the first opening and the door portion is closed.

In addition, the lock structure of the present invention includes a base portion, a door portion, a lock mechanism, a locking section, and a first mating element. The door portion is pivotally connected to one end of the base portion by a pivot and is switched between an open status and a close status, wherein the base portion and the door portion define a first opening, the door portion includes a first securing element close to the first opening. The lock mechanism and the locking section are disposed at the door portion and the base portion, respectively, wherein the lock mechanism and the locking section correspond to each other. One end of the first mating element includes a first engaging portion selectively connected to or detached from the first opening, wherein the first securing element restricts the first engaging portion from being detached from the first opening when the first engaging portion is located at the first opening and the door portion is closed.

The first securing element of the above lock structure is retractable with respect to the door portion. An elastic member is located between the first securing element and the door portion. The elastic member forces the first securing element to usually protrude out of the door portion. The first securing element includes a guiding face located at one end of the first securing element away from the door portion; the guiding face further faces the first opening when the door portion is closed.

The first mating element of the above mating element is connected to one end of a long-shaped object. The above-mentioned long-shaped object may be a strap; meanwhile, one of the base portion and the door portion includes a slit for the strap passing through and the other includes a strap-pressing element. The strap-pressing element restricts the strap from moving when the door portion is closed.

The above lock structure may further include a burglarproof chip disposed at an unapproachable position at the door portion when the door portion is closed, wherein the first mating element is a tongue portion of an electronic product.

One of the base portion and the door portion of the above-mentioned lock structure further includes a second opening different from the first opening and the other includes a second securing element extending into the second opening. The lock structure further includes a second mating piece/element. One end of the second mating element includes a second engaging portion selectively connected to or detached from the second opening, wherein the second securing element restricts the second engaging portion from being detached from the second opening when the second engaging portion is located at the second opening and the door portion is closed.

The base portion and the door portion of the above lock structure further define a second opening different from the first opening; at least one of the base portion and the door portion includes a second securing element extending into the second opening. The lock structure further includes a second mating element. One end of the second mating element includes a second engaging portion selectively connected to or detached from the second opening, wherein the second securing element restricts the second engaging portion from being detached from the second opening when the second engaging portion is located at the second opening and the door portion is closed.

The first mating element of the above lock structure is connected to one end of a long-shaped object; the other end of the long-shaped object is connected to the second mating element. In addition, in other embodiments, the second mating element is a tongue portion of an electronic product.

### BRIEF DESCRIPTION OF THE DRAWINGS

FIG. 1 shows a three-dimensional view of an embodiment of the lock structure of the present invention.

FIG. 2 shows a three-dimensional view of the lock structure shown in FIG. 1 having the door portion in the open status.

FIG. 3 shows another angle of the three-dimensional view of the lock structure shown in FIG. 2.

FIG. 4 shows an exploded view of the lock structure shown in FIG. 1.

FIG. 5A shows an exploded view of a variant embodiment of the lock structure shown in FIG. 1.

FIG. 5B shows a cross-sectional view of the embodiment of the lock structure shown in FIG. 5A.

FIG. 6 shows a three-dimensional view of a variant embodiment of the lock structure shown in FIG. 1.

FIG. 7 shows a three-dimensional view of a variant embodiment of the lock structure shown in FIG. 1.

FIG. 8 shows a three-dimensional view of a variant embodiment of the lock structure shown in FIG. 1.

FIG. 9 shows a three-dimensional view of a variant embodiment of the lock structure shown in FIG. 1.

FIG. 10 shows a three-dimensional view of another embodiment of the lock structure of the present invention.

FIG. 11 shows a three-dimensional view of the lock structure shown in FIG. 10 having the door portion in the open status.

FIG. 12 shows another angle of the three-dimensional view of the lock structure shown in FIG. 11.

FIG. 13 shows an exploded view of the lock structure shown in FIG. 10.

### DETAILED DESCRIPTION OF THE PREFERRED EMBODIMENT

Hereinafter, embodiments of the present invention are illustrated in detail with reference to the drawings.

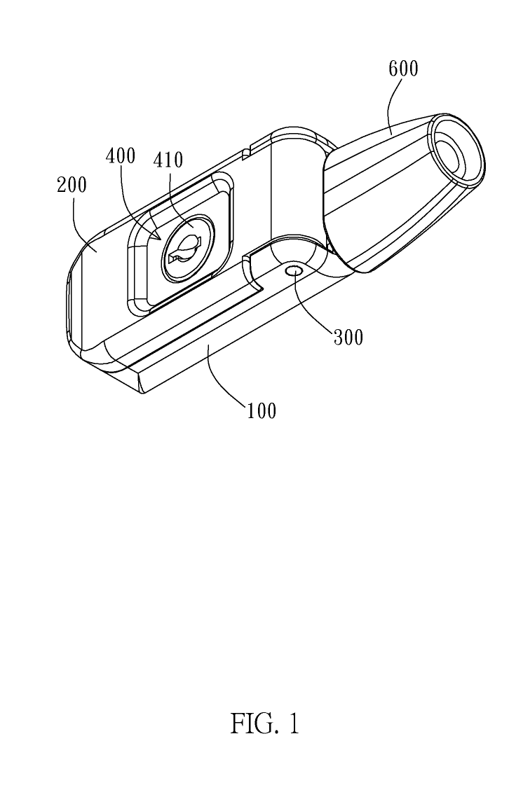

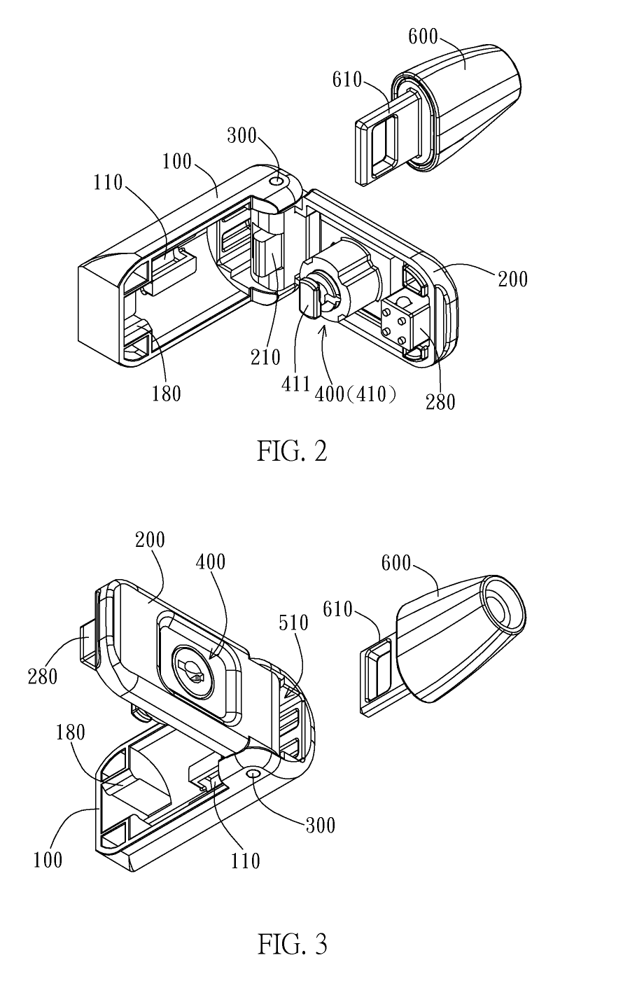

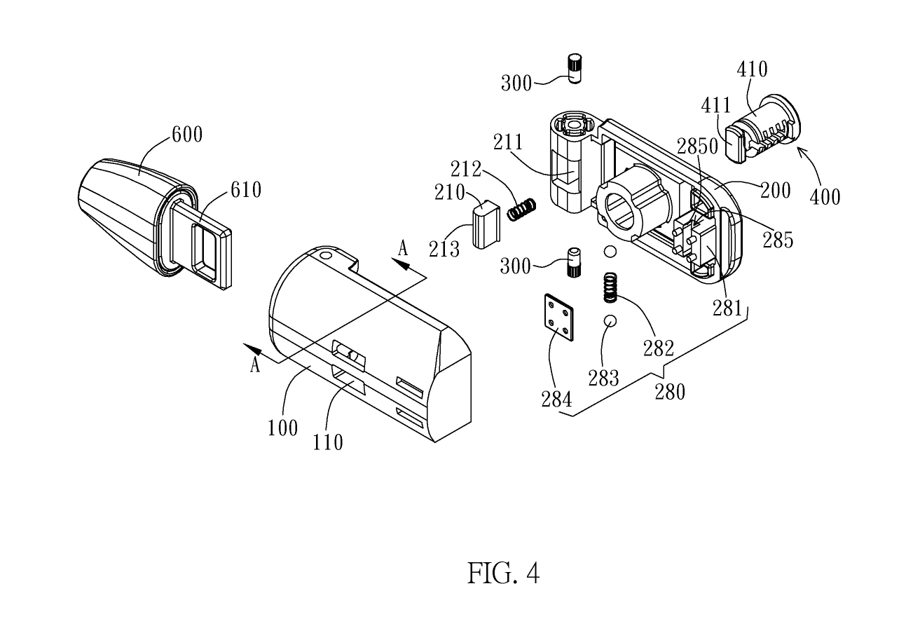

FIG. 1 shows a three-dimensional view of an embodiment of the lock structure of the present invention. FIG. 2 shows a three-dimensional view of the lock structure shown in FIG. 1 having the door portion in the open status. FIG. 3 shows another angle of the three-dimensional view of the lock structure shown in FIG. 2. FIG. 4 shows an exploded view of the lock structure shown in FIG. 1. As shown in the figures, the lock structure of the present invention includes a base portion 100 and a door portion 200, which is pivotally connected to one end of the base portion 100 by a pivot 300 and switched between an open status and a close status. A cross-section of the base portion 100 looks as a U-shaped figure, wherein the cross-section is obtained along the line A-A (shown in FIG. 4) that is perpendicular to an extension direction of the base portion 100. The door portion 200 is pivotally connected between two standing walls of the U-shaped base portion 100. The U-shaped base portion 100 and the door portion 200 define a first opening 510 at the end where pivot connection is disposed. The door portion 200 includes a first securing element 210 that is disposed close to the first opening 510. The first securing element 210 extends from the door portion 200 toward the base portion 100 by a determined length when the door portion 200 is closed with respect to the base portion 100.

The base portion 100 and the door portion 200 include a locking section 110 and a lock mechanism 400. The locking section 110 and the lock mechanism 400 correspond to each other. When the door portion 200 is closed with respect to the base portion 100, the locking section 110 and the lock mechanism 400 are locked to each other. In the embodiment shown in FIGS. 1-4, the locking section 110 is disposed at the base portion 100; the lock mechanism 400 is disposed at the door portion 200 and corresponds to the locking section 110, but not limited thereto. The locations of the locking section 110 and the lock mechanism 400 are exchangeable. In addition, in the embodiment shown in FIGS. 1-4, the lock mechanism 400 includes a key lock mechanism 410; the lock mechanism 400 and the locking section 110 are operated and unlocked or locked by means of inserting a key (now shown) into the key lock mechanism 410 to operate the tongue portion 411.

The lock structure of the present invention is used in cooperation with a variety of mating pieces/elements in accordance with a variety of uses. A first mating element 600 shown in FIGS. 1-4 can be connected with a long-shaped object such as a steel wire, a strap, and a chain. The first mating piece/element 600 is further formed in one end a first engaging portion 610. The first engaging portion 610 can be selectively connected to or detached from the first opening 510. When the first engaging portion 610 is inserted into and located at the first opening 510 and the door portion 200 is closed with respect to the base portion 100, the first securing element 210 interferes with the first engaging portion 610 and restricts the first engaging portion 610 from being pulled out of the first opening 510. When the door portion 200 is opened with respect to the base portion 100, the first securing element 210 and the first engaging portion 610 can be released from the interference, so that the first engaging portion 610 may be pulled out of the first opening 510. Specifically, as shown in FIGS. 1-4, the first engaging portion 610 is formed as a closed ring; the first securing element 210 is a short column, which may pass through the closed ring of the first securing element 610 and protrudes from the door portion 200. The short column of the first securing element 210 leaves or passes through the closed ring of the first securing element 610 in accordance with an opening operation or a closing operation of the door portion 200 with respect to the base portion 100; the first mating element 600 is therefore allowed to move or is connected and limited.

For the convenience of inserting the first engaging portion 610 into the first opening 510, the first securing element 210 is retractable with respect to the door portion 200. Specifically, the door portion 200 has a trough 211 where the first securing element 210 is located. The first securing element 210 is interfered with the trough 211, wherein the first securing element 210 is restricted from leaving the trough 211 but only retractably moves in the trough 211. An elastic member 212 is disposed between the first securing element 210 and the door portion 200 and is specifically located in the trough 211. The elastic member 212 forces the first securing element 210 to usually protrude out of the door portion 200. In addition, the first securing element 210 includes a guiding face 213 located at one end of the securing element 210 away from the door portion 200. When the door portion 200 is closed with respect to the base portion 100, the guiding face 213 faces the first opening 510.

By means of the above-mentioned structure, even the door portion 200 is closed with respect to the base portion 100, the first engaging portion 610 will contact against the first securing element 210, move along the guiding face 213 and press the first securing element 210 toward the trough 211 when the first mating element 600 is inserted into the first opening 510 by the first engaging portion 610. In the meanwhile, the elastic member 212 is pressed by the first engaging portion 210, deforms and is able to release elasticity. When the first engaging portion 610 is continuously inserted to a position where the first securing element 210 is able to pass through the first engaging portion 610 and interferes with the same, the first engaging portion 610 does not press the first securing element 210 any longer and the elasticity of the elastic member 212 is released to push the first securing element 210. The first securing element 210 therefore interferes with the first engaging portion 610 and restricts the first engaging portion 610 from being pulled out of the first opening 510. Under such a configuration, in order to pull the first mating piece/element 600 out of the first opening 510, the lock mechanism 400 must be operated to release the door portion 200 and the base portion 100 from an locked status and allow the door portion 200 be open with respect to the base portion 100. As such, the interferences between the first securing element 210 and the first engaging portion 610 can be released, and the first engaging portion 610 may be pulled out of the first opening 510.

In addition, a closing element 280 and a protrusion 180 may be disposed between the base portion 100 and the door portion 200. As the embodiment shown in FIGS. 2 and 3, the protrusion 180 is disposed at the base portion 100 and the closing element 280 is disposed at the door portion 200, but not limited thereto. The positions of the protrusion 180 and the closing element 280 are exchangeable.

As shown in FIG. 4, the closing element 280 includes a seat 281, an elastic member 282, at least one bead 283, and a lid 284. The seat 281 is disposed at a position of the door portion 200 departed from the pivot 300 of the door portion 200. The seat 281 has an elongated trough 285 formed thereon. The elongated trough 285 extends to two opposite ends of the seat 281 and two notches 2850 are formed at the two opposite ends. The elastic member 282 is disposed in the elongated trough 285 along an extension direction thereof. The beads 283 are disposed at ends of the elastic member 282; the beads 283 are interfered by the notches 2850 of the elongated trough 285 and slightly protrude out of the notches 2850 rather than passing the notches 2850 to run out of the elongated trough. The beads 283 are forced by the elastic member 282 and are usually maintained in a status of slightly protruding out of the notches 2850. The lid 284 is disposed on the seat 281 and restrains the elastic member 282 and the beads 283 so that the elastic member 282 and the beads 283 preferably act in the elongated trough 2850.

The protrusion(s) 180 are disposed at the base portion 100 and correspond to positions where the beads 283 are disposed. The protrusion 180 preferably protrudes to a degree so that the protrusion 180 will press the bead 283 to retract toward the notches 2850. Then, the beads 283 will return back to the protruding status after passing the protrusions 180.

When closing the door portion 200 with respect to the base portion 100 and the beads 283 of the closing element 280 contacting the protrusions 180, the protrusions 180 will naturally press the beads 283 to retract into the elongated trough 285 from the notches 2850 along with a closing movement of the door portion 200 toward the base portion 100; meanwhile, the elastic member 282 is pressed, deforms and stores elasticity. After the beads 283 passing the protrusions 180, the elastic member 282 releases the elasticity and allows the beads 283 to return back to the status of protruding out of the notches 2850 and to be interfered by the protrusions 180. Accordingly, it enhances a feel of the operation of closing the door portion 200 with respect to the base portion 100. Furthermore, the door portion 200 may be engaged with the base portion 100 even the lock mechanism 400 of the closed base portion 100 and the door portion 200 is not yet in the locking status. The door portion 200 and the base portion 100 are therefore prevented from oscillating and can be stored well. A force for the engagement of the door portion 200 and the base portion 100 is preferably weaker than the force of the above-mentioned elastic member 212 in order to prevent the lock mechanism 400 from being unlocked when the first mating element 600 is inserted into the closed but unlocked door portion 200 and the base portion 100. When opening the door portion 200 with respect to the base portion 100, the protrusions 180 and the closing element 280 may act by a process reverse to the above-mentioned process; the details will not be addressed any more herein.

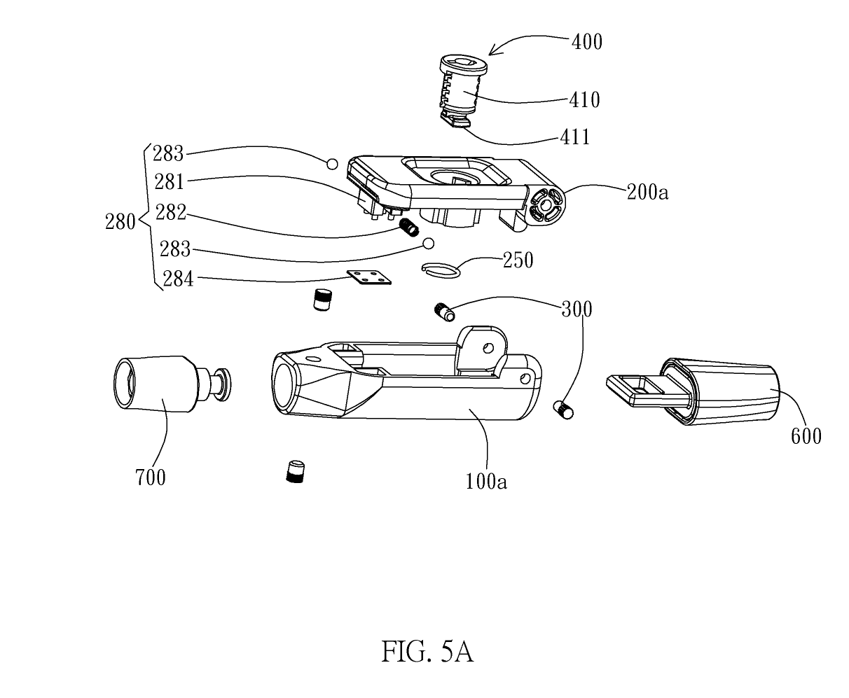

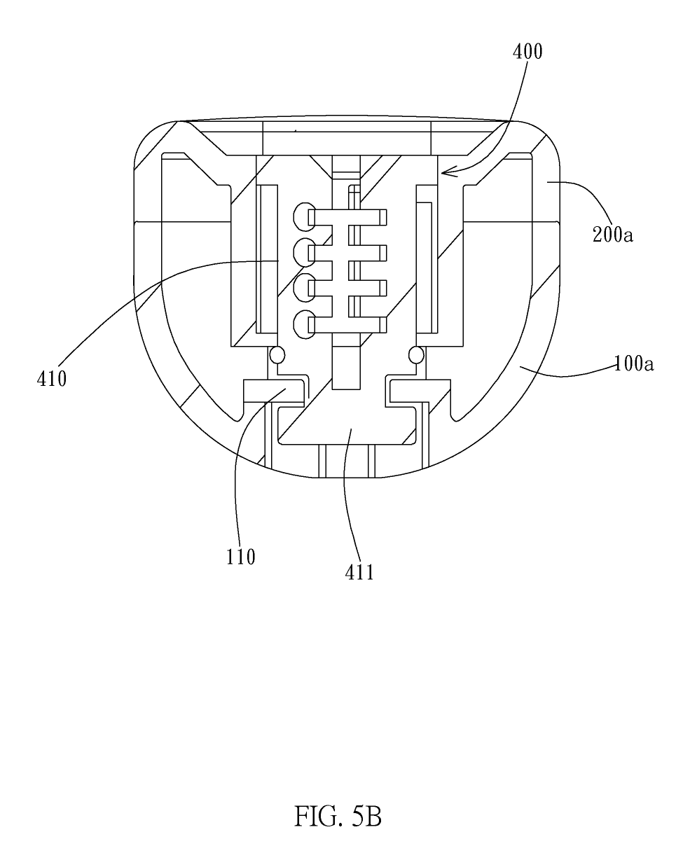

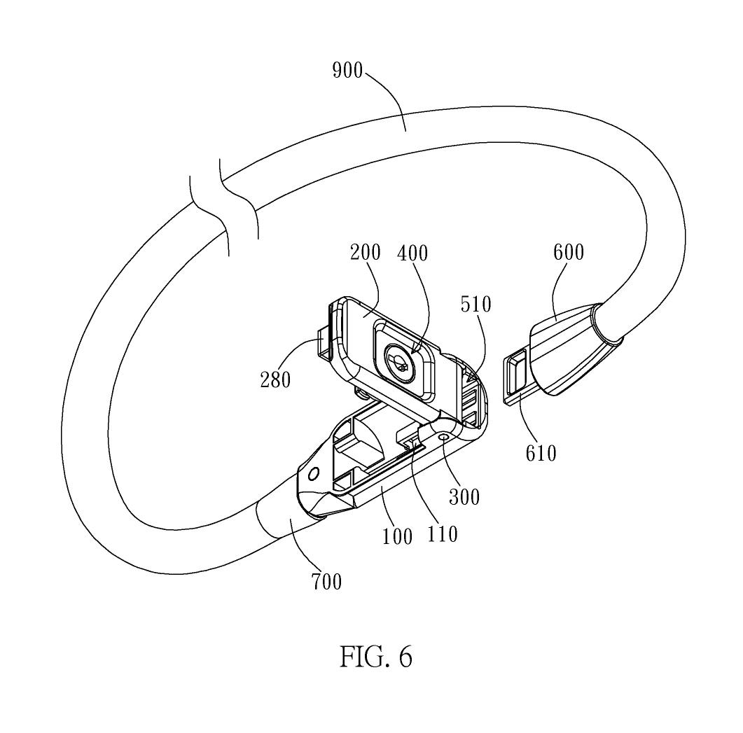

FIGS. 5A-5B show three-dimensional views of a variant embodiment of the lock structure shown in FIG. 1. Hereinafter, the other embodiment of the present invention is illustrated in detail with reference to the drawings; the elements in FIGS. 5A-5B similar to those in FIGS. 1-4 will have same reference symbols. The details are not addressed any more herein.

As FIG. 5A-5B show, the lock structure of the present invention includes a lower housing 100a and an upper housing 200a, which is pivotally connected to one end of the lower housing 100a by a pivot 300 and switched between an open status and a close status. In addition, the lower housing 100a and the upper housing 200a constitute a housing/casing of the lock structure. A cross-section of the lower housing 100a looks as a U-shaped figure, wherein the cross-section is obtained in accordance with a line perpendicular to an extension direction of the lower housing 100a, as shown in FIG. 5B. The upper housing 200a is pivotally connected between two standing walls of the U-shaped lower portion 100a. The lower housing 100a and the upper housing 200a act similar to the base portion 100 and the door portion 200 of FIGS. 1-4.

The lower housing 100a and the upper housing 200a include a locking section 110 and a lock mechanism 400, which correspond to each other. When the upper housing 200a is closed with respect to the lower housing 100a, the locking section 110 and the lock mechanism 400 are locked to each other. In the embodiment shown in FIGS. 5A-5B, the locking section 110 is disposed at the lower housing 100a; the lock mechanism 400 is disposed at the upper housing 200a and corresponds to the locking section 110, but not limited thereto. The locations of the locking section 110 and the lock mechanism 400 are exchangeable. In addition, in the embodiment shown in FIGS. 5A-5B, the lock mechanism 400 includes a key lock mechanism 410. The lock mechanism 400 and the locking section 110 are operated and unlocked or locked by means of inserting a key (now shown) into the key lock mechanism 410 to operate the tongue portion 411. For example, the tongue portion 411 may be rotated under the operation of the key and the key lock mechanism 410 and enter the locking section 110 to be secured therein, as shown in FIG. 5B.

FIGS. 6-9 show three-dimensional views of a variant embodiment of the lock structure shown in FIG. 1. Hereinafter, various embodiments of the present invention are illustrated in detail with reference to the drawings; the elements in FIGS. 6-9 similar to those in FIGS. 1-4 will have the same reference symbols. The details are not addressed any more herein.

As FIG. 6 shows, in the embodiment, one end of a steel wire-like long-shaped object is connected to the first mating element 600. The other end of the steel wire-like long-shaped object is connected to a connecting element 700, which is disposed at one end of the base portion 100. As a result, the long-shaped object 900 may pass through a bicycle stand or a wheel set; the first mating element 600 is then inserted into the first opening 510 by the first engaging portion 610 so that the lock structure and the long-shaped object 900 form a closed ring, which provides a burglarproof function to the a bicycle.

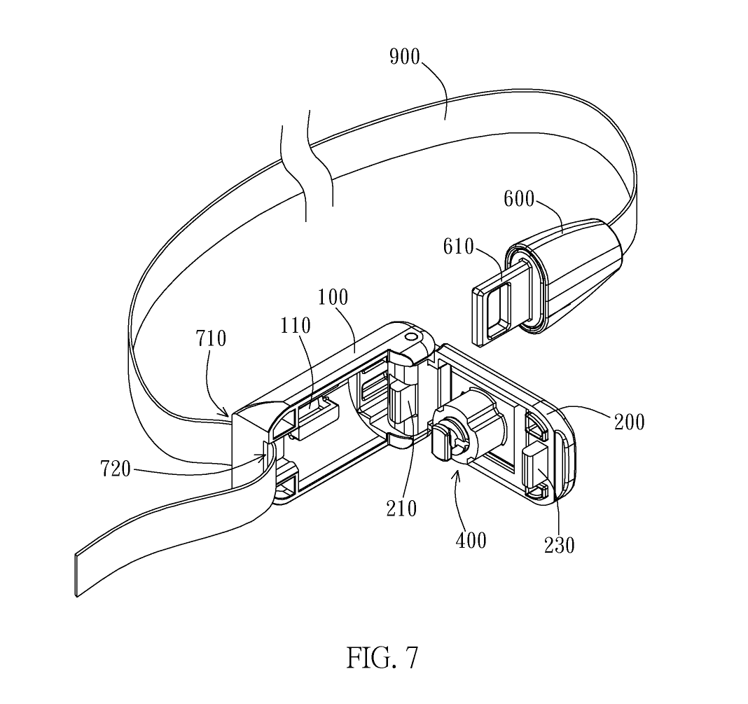

As FIG. 7 shows, in the present embodiment, the long-shaped object 900 is a strap. One end of the strap is connected to the first mating element 600; the other end of the strap is a free end. A slit 710 is formed on the base portion 100 for the long-shaped object 900 passing through. A notch 720 is further formed for the long-shaped object 900 passing through. A strap-pressing element 230 is further disposed on a position at the door portion 200, wherein the position corresponds to the notch 720. The free end of the strap-like long-shaped object 900 passes through the slit 710 from an outer side of the base portion 100, enters the base portion 100, and leaves the base portion 100 from the notch 710. When the door portion 200 is closed with respect to the base portion 100, the strap-pressing element 230 presses the strap-like long-shaped object 900 to prevent the strap-like long-shaped object 900 from moving between the slit 710 and the notch 720. In such a situation, the lock structure and the strap-like long-shaped object 900 will form a closed ring with an adjustable loop length. However, the loop length of the closed ring formed by the lock structure and the strap-like long-shaped object 900 will be fixed when the first mating element 600 is inserted into the first opening 510 by the first engaging portion 610. Accordingly, the lock structure of the present invention and the mating piece/element with the strap-like long-shaped object may be applied in packing a luggage up. As the embodiment shown in FIG. 7, the slit 710 and the notch 720 are form on the base portion 100; the strap-pressing element 230 is disposed at the door portion 200, but not limited thereto. For example, the slit 710 and the notch 720 may be formed on the door portion 200 while the strap-pressing element 230 is disposed at the base portion 100.

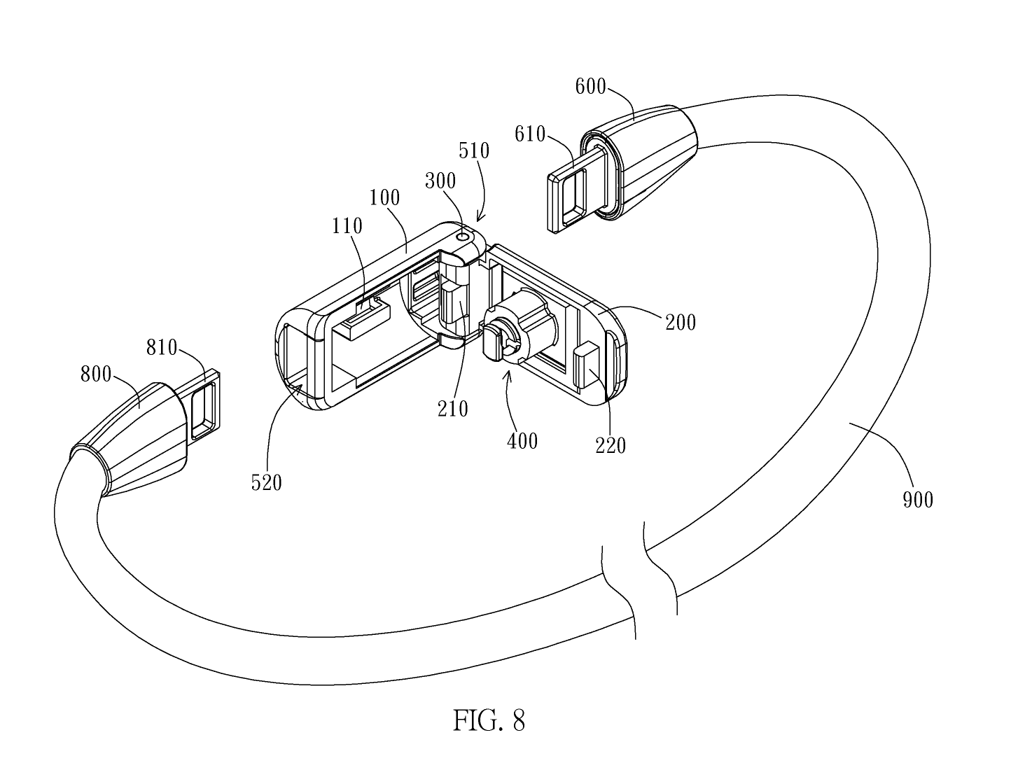

As shown in FIG. 8, in the embodiment, the base portion 100 further includes a second opening 520 different from the first opening 510. A second securing element 220 is disposed at the door portion 200. The second securing element 220 extends from the door portion 200 toward the second opening 520 when the door portion 200 is closed with respect to the base portion 100. The lock structure further includes a second mating piece/element 800, wherein one end of the second mating element 800 includes a second engaging portion 810. The second engaging portion 810 is selectively connected to or detached from the second opening 520. The second securing element 220 restricts the second engaging portion 810 from being detached from the second opening 520 when the second engaging portion 810 is inserted into and located at the second opening 520 and the door portion 200 is closed. Although not shown, however, the second securing element 220 can be retractable with respect to the door portion 200 in a manner similar to the first securing element 120 and also has a guiding face, which allows the second mating element 800 to be inserted into the second opening 520 by the second engaging portion 810 even the door portion 200 is closed with respect to the base portion 100. One end of the long-shaped object 900 may be connected to the first mating element 600, and the other end of the long-shaped object 900 may be connected to the second mating element 800. As the first mating element 600 and the second mating element 800 are inserted into the locked lock structure respectively through the first opening 510 and the second opening 520, the lock structure together with the long-shaped object 900 will form a closed ring to achieve the burglarproof purpose for a bicycle. In addition, when the lock structure having the first mating element 600 and the second mating element 800 that can be selectively connected to or detached from the first opening 510 and the second opening 520, if the length of a single long-shaped object 900 is not long enough, a plurality of long-shaped objects can work with a plurality of lock structures to form a closed ring with a longer loop length.

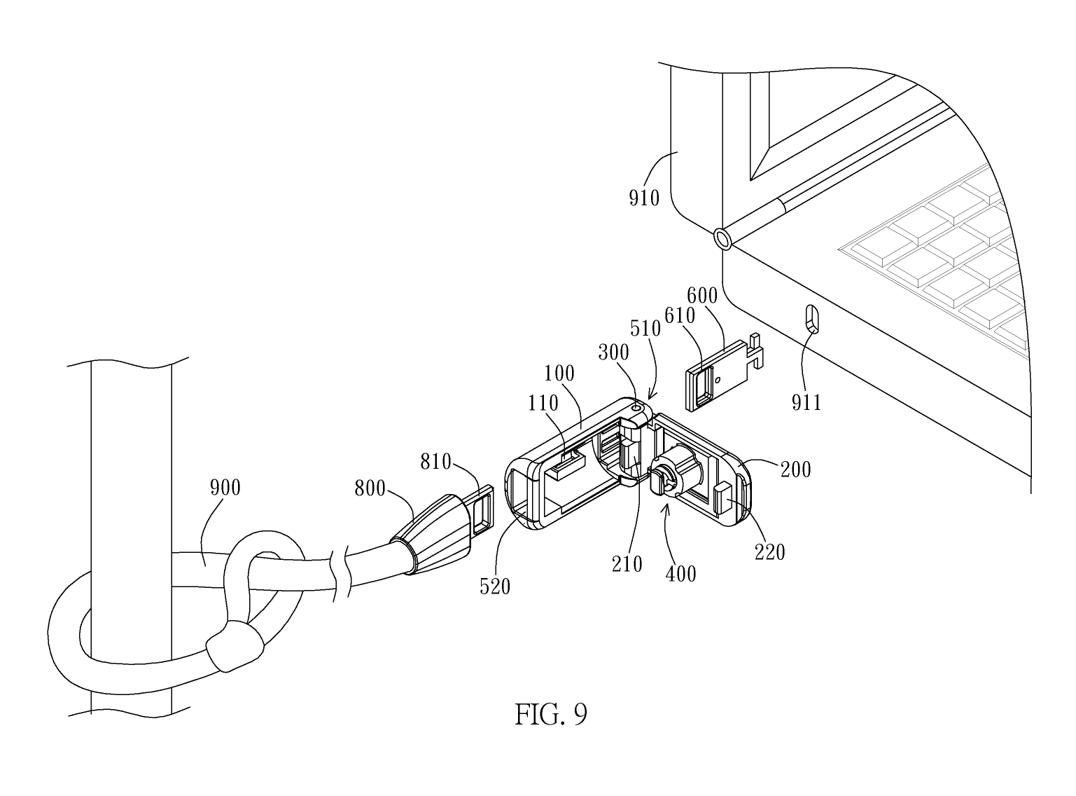

As the embodiment shown in FIG. 9, the first mating element 600 serves as a tongue portion of an electronic product 910, which can intervene in the lock hole 911; the second mating element 800 is connected to a long-shaped object 900 with one end formed as a loop to achieve the burglarproof function for the electronic product.

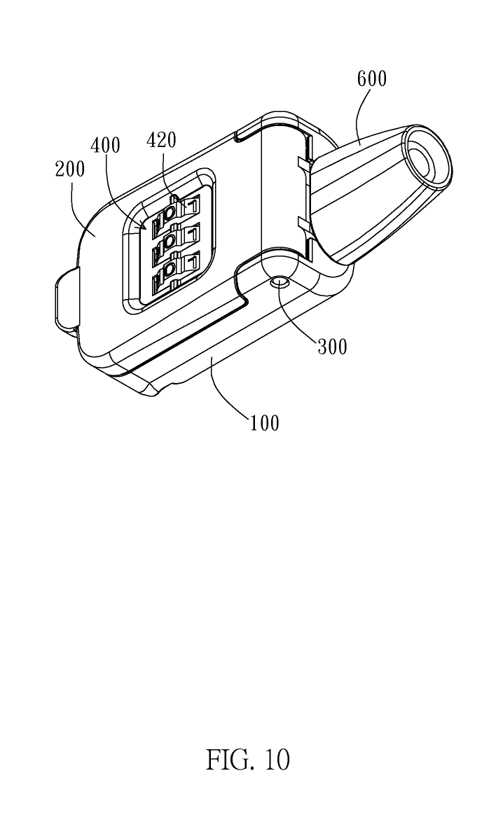

Above embodiments are exemplified with the lock structure 400 including the key lock mechanism 410. In the embodiments shown in FIGS. 10-13, however, the lock structure 400 may include a combination lock mechanism 420. Hereinafter, embodiments of the combination lock mechanism 420 of the lock mechanism 400 are illustrated in detail with reference to the drawings. The elements herein similar to those in FIGS. 1-4 have the same reference symbols and the details are not addressed any more.

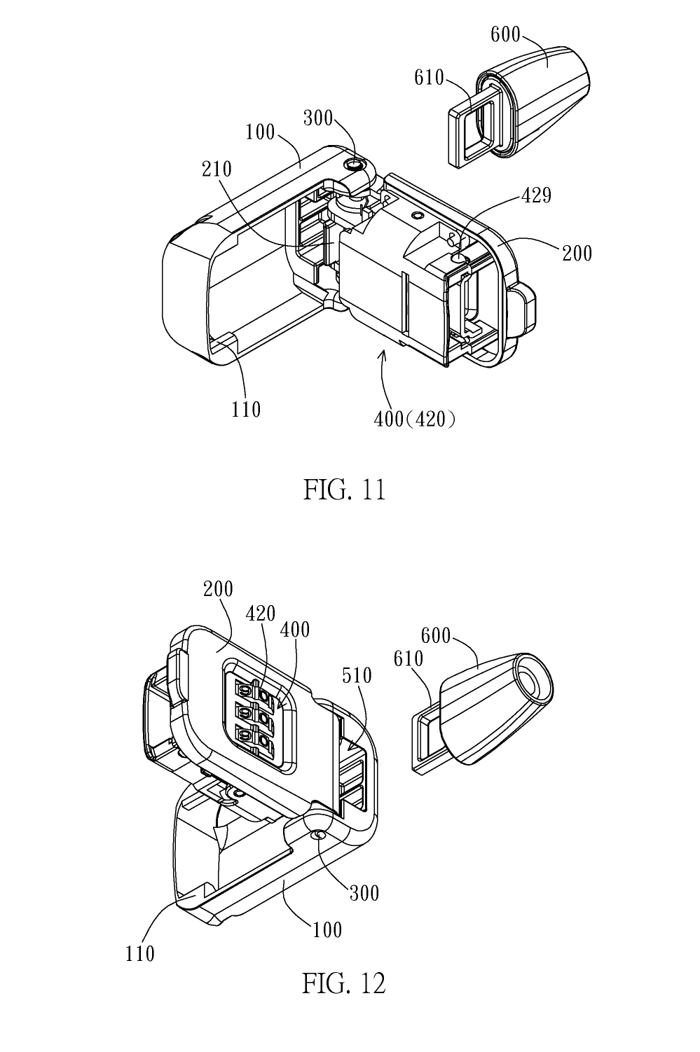

As shown in FIG. 10, the lock structure of the embodiment has the combination lock mechanism 420 of the lock mechanism 400. As shown in FIGS. 11-12, the tongue portion 411 in the key lock mechanism 410 is replaced by bead(s) 429 in the combination lock mechanism 420. The locking section 110 is disposed at the base portion 100 and corresponds to the bead(s) 429.

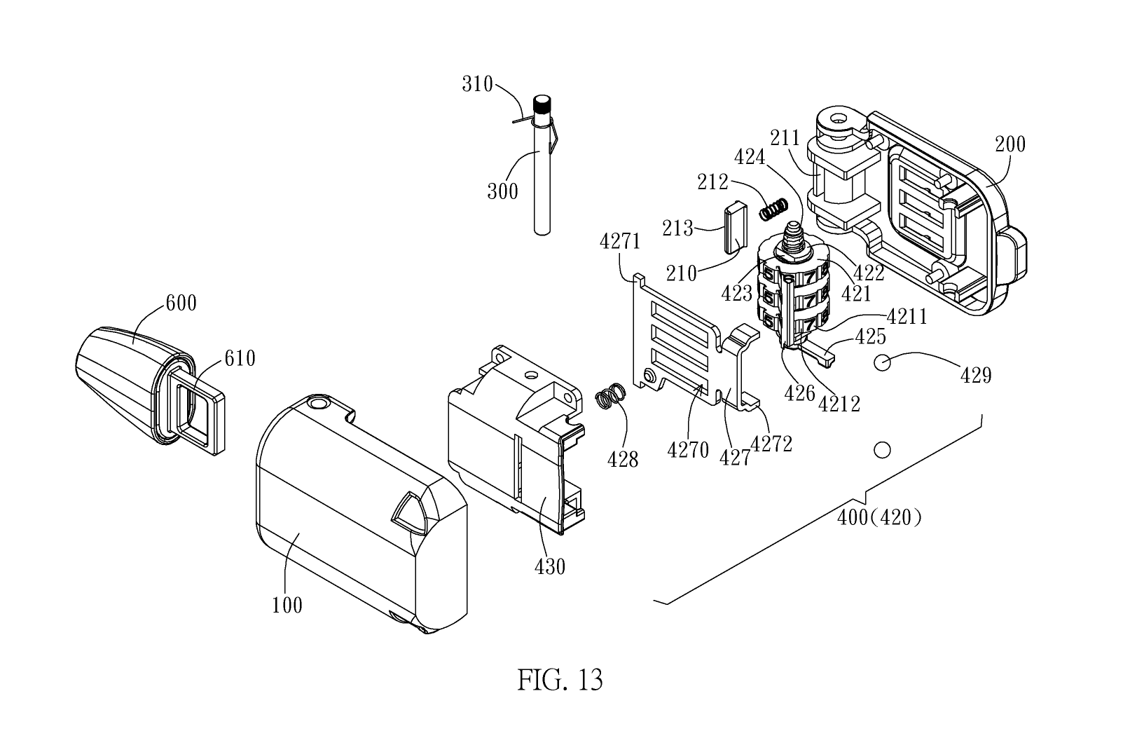

FIG. 13 shows an exploded view of the lock structure shown in FIG. 10. As the figure shows, the combination lock mechanism 420 includes a plurality of wheels 421 and cam wheels 422, wherein the wheels 421 are arranged parallelly with an axis 424 passing therethrough; the cam wheels 422 are coupled with the plurality of wheels 421 and may rotate along with the wheels 421. Sections 4211, which have such as a plurality of numbers, respectively, are disposed on the wheel. A dimple 4212 is disposed between adjacent sections 4211. Each cam wheel 422 has an edge 423. A user can set preferred combination for unlocking by means of a setting mechanism 425 that is disposed at one end of the axis 424 to operate the coupling and separating of the wheels 421 and cam wheels 422. A spring leaf 426 and a pushing plate 427 are disposed on a wheel set including the wheels 421 and the cam wheels 422. The front end of the spring leaf 426 contacts against the dimple 4212 of the adjacent sections 4211 of the wheels 421 to enhance a feel of the operation when rotating the wheels 421 by section. A plurality of openings 4270 are formed on the middle portion of the pushing plate 427 for the wheels 421 protruding while the cam wheels 422 are adjacent to portions of the pushing plate 427 where no opening is disposed. One end of the pushing plate 427 has a support shaft 4271 extending in a direction along an arrangement orientation of the parallel openings 4270; the other end of the pushing plate 427 is formed with a driving portion 4272 for pushing the bead(s) 429. An elastic member 428 is disposed in the combination lock mechanism 420 and forces the pushing plate 427 in a direction, in which the pushing plate 427 releases the bead(s) 429. The elements of the above-mentioned combination lock mechanism 420 are disposed in the cover 430 and then disposed on the door portion 200. The bead(s) 429 move in a trough defined by the door portion 200 and the cover 430.

When the door portion 200 is closed with respect to the base portion 100 and any of the wheels 421 is not in an unlocking position, the edge of the corresponding cam wheel 422 of the wheel 421 does not face the pushing plate 427, the pushing plate 427 therefore sinks away from the door portion 200; meanwhile, the driving portion 4272 of the pushing plate 427 pushes the bead(s) 429 to be secured in the locking section 110, so that the base portion 100 and the door portion 200 are locked with respect to each other. At the same time, the pushing plate 427 pushes the elastic member 428 to deform and therefore restore elasticity. When operating the wheels 421 to the unlocking positions, the cam wheels 422 are driven so that the plurality of edges 423 all face the pushing plate 427; meanwhile, the elastic member 428 releases elasticity and pushes the pushing plate 427 toward the door portion 200, so that the bead(s) 429 are released from being pushed by the pushing plate 427. As a result, the bead(s) 429 are released from the locking section 110, allowing the base portion 100 and the door portion 200 to be in the unlocked status. As mentioned above, the locking section 110 is certainly allowed to be disposed at the door portion 200; the lock mechanism 400 is allowed to be disposed at the base portion 100 at a position and corresponds to the locking section 110.

The combination lock structure shown in FIGS. 10-13 corresponds to the key lock structure shown in FIGS. 1-4 and merely illustrates a basic embodiment of the lock structure of the present invention; however, the key lock mechanism 410 of the key lock structure shown in FIGS. 6-9 are certainly allowed to have their lock mechanism 400 be replaced by the combination lock mechanism 420 and also have the same functions. The details are not addressed any more.

Embodiments of the lock structure of the present invention are illustrated in detail above with reference to the drawings; however, the present invention is not limited thereto and may include following variant embodiments.

In the embodiments shown in FIGS. 1-4, the first opening 510 is defined by the base portion 100 and the door portion 200; in the embodiments shown in FIGS. 8 and 9, the second opening 520 is at the base portion 100. However, the first opening 510 and the second opening 520 can be selectively disposed at any one of the base portion 100 and the door portion 200; the first securing element 210 and the second securing element 220 are close to the first opening 510 and the second opening 520, respectively, wherein the first securing element 210 is disposed at a position of the base portion 100 or a position of the door portion 200 and corresponds to the first opening 510, the second securing element 220 is disposed at a position of the base portion 100 or a position of the door portion 200 and corresponds to the first opening 510; the base portion 100 or the door portion 200, which has the first securing element 210 disposed thereat, does not have the first opening 510, the base portion 100 or the door portion 200, which has the second securing element 220 disposed thereat, does not have the second opening 520. The second opening 520 certainly may be defined by the base portion 100 and the door portion 200.

The first securing element 210 mentioned above is exemplified by the retractable first securing element 210 with respect to the trough 211, but not limited thereto. For example, the first securing element 210 is pivotally connected to the trough 211 by a rotation axis; a torsional spring can be disposed between the first securing element 210 and the trough 211 and forces the first securing element 210 to protrude out of the trough 211 and toward the first opening 510, wherein the first securing element 210 is retractable into the trough 211 when the first engaging portion 600 is inserted into the first opening 510.

When the lock structure of the embodiment shown in FIGS. 1-4 are used in cooperation with the first mating element 600 of the electronic product shown in FIG. 9, which has the tongue portion, the lock structure may further include a burglarproof chip disposed at a position, which is unapproachable when the door portion 200 is closed with respect to the base portion 100. When such a lock structure is applied to and locks electronic products in a shop, a warning device will act due to the burglarproof chip when the lock structure passes a burglarproof gate of the shop, so that the lock structure provides a burglarproof function. Furthermore, the lock structure having the burglarproof chip may be re-useable, which is not like a burglarproof tag attached to the merchandise and discarded when the merchandise is sold; accordingly, cost for burglarproof tags is saved, the prevention from tag-discarding is environmental friendly.

The base portion 100 and the door portion 200 of every embodiment are pivotally connected; the base portion 100 and the door portion 200 rotate with respect to each other by the pivot 300. As FIG. 13 shows, an elastic member 310 may be disposed at the pivot 300; the elastic member 310 forces the base portion 100 and the door portion 200, wherein a forcing direction is an opening direction or a closing direction of the door portion 200 with respect to the base portion 100, so that the user will not have to force the door portion 200 to open or close.

Although the preferred embodiments of present invention have been described herein, the above description is merely illustrative. The preferred embodiments disclosed will not limit the scope of the present invention. Further modification of the invention herein disclosed will occur to those skilled in the respective arts and all such modifications are deemed to be within the scope of the invention as defined by the appended claims.

What is claimed is:

1. A lock structure, including:
a base portion;
a door portion pivotally connected to one end of the base portion by a pivot, and being switched between an open and a close status, wherein one of the base portion and the door portion comprises a first opening and the other comprises a first securing element close to the first opening;
a lock mechanism and a locking section disposed at the door portion and the base portion, respectively, wherein the lock mechanism and the locking section correspond to each other; and
a first mating element, one end of the first mating element comprises a first engaging portion selectively connected to or detached from the first opening, wherein the first securing element restricts the first engaging portion from being detached from the first opening when the first engaging portion is located at the first opening and the door portion is closed.

2. The lock structure of claim 1, wherein the first securing element is retractable with respect to the door portion, an elastic member is located between the first securing element and the door portion, the elastic member forces the first securing element to usually protrude out of the door portion.

3. The lock structure of claim 2, wherein the first securing element comprises a guiding face located at one end of the first securing element away from the door portion, the guiding face further faces the first opening when the door portion is closed.

4. The lock structure of claim 1, wherein the first mating element is connected to one end of a long-shaped object.

5. The lock structure of claim 4, wherein the long-shaped object is a strap, one of the base portion and the door portion comprises a slit for the strap passing through and the other comprises a strap-pressing element, the strap-pressing element restricts the strap from moving when the door portion is closed.

6. The lock structure of claim 1 further comprising a burglarproof chip disposed at an unapproachable position at the door portion when the door portion is closed, wherein the first mating element is a tongue portion of an electronic product.

7. The lock structure of claim 1, wherein one of the base portion and the door portion further comprises a second opening different from the first opening and the other comprises a second securing element extending into the second opening; the lock structure further comprises a second mating element, one end of the second mating element comprises a second engaging portion selectively connected to or detached from the second opening, wherein the second securing element restricts the second engaging portion from being detached from the second opening when the second engaging portion is located at the second opening and the door portion is closed.

8. The lock structure of claim 1, wherein the base portion and the door portion further define a second opening different from the first opening, at least one of the base portion and the door portion comprises a second securing element extending into the second opening; the lock structure further comprises a second mating element, one end of the second mating element comprises a second engaging portion selectively connected to or detached from the second opening, wherein the second securing element restricts the second engaging portion from being detached from the second opening when the second engaging portion is located at the second opening and the door portion is closed.

9. The lock structure of claim 7, wherein the first mating element is connected to one end of a long-shaped object.

10. The lock structure of claim 9, wherein the other end of the long-shaped object is connected to the second mating element.

11. The lock structure of claim 9, wherein the second mating element is a tongue portion of an electronic product.

12. The lock structure of claim 8, wherein the first mating element is connected to one end of a long-shaped object.

13. The lock structure of claim 12, wherein the other end of the long-shaped object is connected to the second mating element.

14. The lock structure of claim 12, wherein the second mating element is a tongue portion of an electronic product.

15. A lock structure, including:
a base portion;
a door portion, pivotally connected to one end of the base portion by a pivot, and being switched between an open and an close status, wherein the base portion and the door portion define a first opening, the door portion comprises a first securing element close to the first opening;
a lock mechanism and a locking section disposed at the door portion and the base portion, respectively, wherein the lock mechanism and the locking section correspond to each other; and
a first mating element, one end of the first mating element comprises a first engaging portion selectively connected to or detached from the first opening, wherein the first securing element restricts the first engaging portion from being detached from the first opening when the first engaging portion is located at the first opening and the door portion is off.

16. The lock structure of claim 15, wherein the first securing element is retractable with respect to the door portion, an elastic member is located between the first securing element and the door portion, the elastic member forces the first securing element to usually protrude out of the door portion.

17. The lock structure of claim 16, wherein the first securing element comprises a guiding face located at one end of the first securing element away from the door portion, the guiding face further faces the first opening when the door portion is closed.

18. The lock structure of claim 15, wherein the first mating element is connected to one end of a long-shaped object.

19. The lock structure of claim 18, wherein the long-shaped object is a strap, one of the base portion and the door portion comprises a slit for the strap passing through and the other comprises a strap-pressing element, the strap-pressing element restricts the strap from moving when the door portion is closed.

20. The lock structure of claim 15 further comprising a burglarproof chip disposed at an unapproachable position at the door portion when the door portion is closed, wherein the first mating element is a tongue portion of an electronic product.

21. The lock structure of claim 15, wherein one of the base portion and the door portion further comprises a second opening different from the first opening and the other comprises a second securing element extending into the second opening; the lock structure further comprises a second mating element, one end of the second mating element comprises a second engaging portion selectively connected to or detached from the second opening, wherein the second securing element restricts the second engaging portion from being detached from the second opening when the second engaging portion is located at the second opening and the door portion is closed.

22. The lock structure of claim 15, wherein the base portion and the door portion further define a second opening different from the first opening, at least one of the base portion and the door portion comprises a second securing element extending into the second opening; the lock structure further comprises a second mating element, one end of the second mating element comprises a second engaging portion selectively connected to or detached from the second opening, wherein the second securing element restricts the second engaging portion from being detached from the second opening when the second engaging portion is located at the second opening and the door portion is closed.

23. The lock structure of claim 21, wherein the first mating element is connected to one end of a long-shaped object.

24. The lock structure of claim 23, wherein the other end of the long-shaped object is connected to the second mating element.

25. The lock structure of claim 23, wherein the second mating element is a tongue portion of an electronic product.

26. The lock structure of claim 22, wherein the first mating element is connected to one end of a long-shaped object.

27. The lock structure of claim 26, wherein the other end of the long-shaped object is connected to the second mating element.

28. The lock structure of claim 26, wherein the second mating element is a tongue portion of an electronic product.
